(19) United States
(12) Patent Application Publication
(10) Pub. No.: US 2025/0353495 A1
(43) Pub. Date: Nov. 20, 2025

(54) DRIVING ASSISTANCE DEVICE

(71) Applicant: ADVICS CO., LTD, Kariya-shi, Aichi-ken (JP)

(72) Inventors: Mayu YAMAMOTO, Kariya-shi, Aichi-ken (JP); Mako NOGUCHI, Kariya-shi, Aichi-ken (JP)

(73) Assignee: ADVICS CO., LTD, KARIYA-SHI, AICHI-KEN (JP)

(21) Appl. No.: 19/101,388

(22) PCT Filed: Sep. 28, 2023
(86) PCT No.: PCT/JP2023/035399

§ 371 Date: Feb. 5, 2025

(30) Foreign Application Priority Data
Sep. 28, 2022 (JP) 2022-154948

(51) Int. Cl. B60W 30/14; B60W 10/04; B60W 10/18

(52) U.S. Cl. CPC B60W 30/143; B60W 10/04; B60W 10/18; B60W 2520/10; B60W 2540/10; B60W 2540/12; B60W 2554/20; B60W 2710/18; B60W 2720/106

(57) ABSTRACT

A driving assistance device executes an assistance control for assisting traveling of a vehicle by causing a vehicle body speed to track a target vehicle body speed through adjustment of a driving force and a braking force of the vehicle. The driving assistance device includes a target vehicle body speed setting unit configured to set the target vehicle body speed. The driving assistance device includes a disturbance detection unit configured to detect a disturbance part present on a travel path. The target vehicle body speed setting unit adjusts the target vehicle body speed according to an accelerating operation amount that is an operation amount of an accelerating operation member operated by a driver of the vehicle when the disturbance part is not detected, and does not reflect the accelerating operation amount on the target vehicle body speed when the disturbance part is detected.

### TECHNICAL FIELD

The present disclosure relates to a driving assistance device for a vehicle.

### BACKGROUND ART

An assistance control that adjusts driving force and braking force of a vehicle to assist traveling of the vehicle is known. For example, Patent Literature 1 discloses a parking assistance device that assists parking of a vehicle to a target parking position set in advance.

### CITATIONS LIST

### Patent Literature

Patent Literature 1: JP 2015-77862 A

### SUMMARY

### Technical Problems

The driver may apply an operation during execution of the assistance control. For example, when the wheel of the traveling vehicle reaches a disturbance part such as a step due to the assistance control, it is conceivable that the driver who feels lowering in the vehicle body speed will operate an accelerating operation member. The device disclosed in Patent Literature 1 does not take into consideration that the driver performs an operation during execution of the assistance control.

### Solutions to Problems

A driving assistance device for solving the above problem is a driving assistance device configured to execute an assistance control for assisting traveling of a vehicle by causing a vehicle body speed of the vehicle to track a target vehicle body speed through adjustment of a driving force and a braking force of the vehicle, the driving assistance device including: a target vehicle body speed setting unit configured to set the target vehicle body speed; and a disturbance detection unit configured to detect a disturbance part present on a travel path of the vehicle; wherein the target vehicle body speed setting unit is configured to adjust the target vehicle body speed according to an accelerating operation amount that is an operation amount of an accelerating operation member operated by a driver of the vehicle when the disturbance part is not detected, and not adjust the target vehicle body speed according to the accelerating operation amount when the disturbance part is detected.

Regarding the assistance control for causing the vehicle body speed of the vehicle to track the target vehicle body speed, for example,
when the vehicle is caused to travel at a constant vehicle body speed, the driving force needs to be increased when a wheel passes through a disturbance part if there is a disturbance part on the travel path of the vehicle. If the wheel passes through the disturbance part in a state where the driving force is increased in order for the wheel to pass through the disturbance part, the vehicle body speed may temporarily increase. At this time, the following problem arises if the target vehicle body speed at the time of passing through the disturbance part is set to be larger than the constant vehicle body speed because the accelerating operation member is operated. Even if the operation of the accelerating operation member is canceled after passing through the disturbance part, there is a possibility that the vehicle that has passed through the disturbance part is controlled to jump out.

According to the above configuration, the accelerating operation amount is not reflected on the target vehicle body speed when the disturbance part present in the travel path is detected. Therefore, when the operation of the accelerating operation member is canceled after passing through the step, the driving force and the braking force are easily controlled in a direction of reducing the vehicle body speed when the wheel passes through the disturbance part. As a result, the vehicle body speed after the wheel passes through the disturbance part can be suppressed from becoming excessively large.

### BRIEF DESCRIPTION OF DRAWINGS

FIG. 1 is a schematic diagram illustrating a driving assistance device of a first embodiment and a vehicle to be controlled by the driving assistance device.

FIG. 2 is a schematic diagram illustrating a vehicle traveled by the driving assistance device of FIG. 1.

FIG. 3 is a flowchart illustrating a flow of processing executed by the driving assistance device of FIG. 1.

FIG. 4 is a timing chart illustrating transition of various states related to the vehicle traveled by the driving assistance device of FIG. 1.

FIG. 5 is a flowchart illustrating a flow of processing executed by a driving assistance device according to a second embodiment.

FIG. 6 is a diagram for explaining a target vehicle body speed set by the driving assistance device of the second embodiment.

FIG. 7 is a diagram for explaining the target vehicle body speed set by the driving assistance device of the second embodiment.

FIG. 8 is a diagram for explaining the target vehicle body speed set by the driving assistance device of the second embodiment.

FIG. 9 is a timing chart illustrating transition of various states related to the vehicle traveled by the driving assistance device of the second embodiment.

FIG. 10 is a timing chart illustrating transition of various states related to the vehicle traveled by the driving assistance device of the second embodiment.

FIG. 11 is a flowchart illustrating a flow of processing executed by a driving assistance device according to a modified example.

### DESCRIPTION OF EMBODIMENTS

### First Embodiment

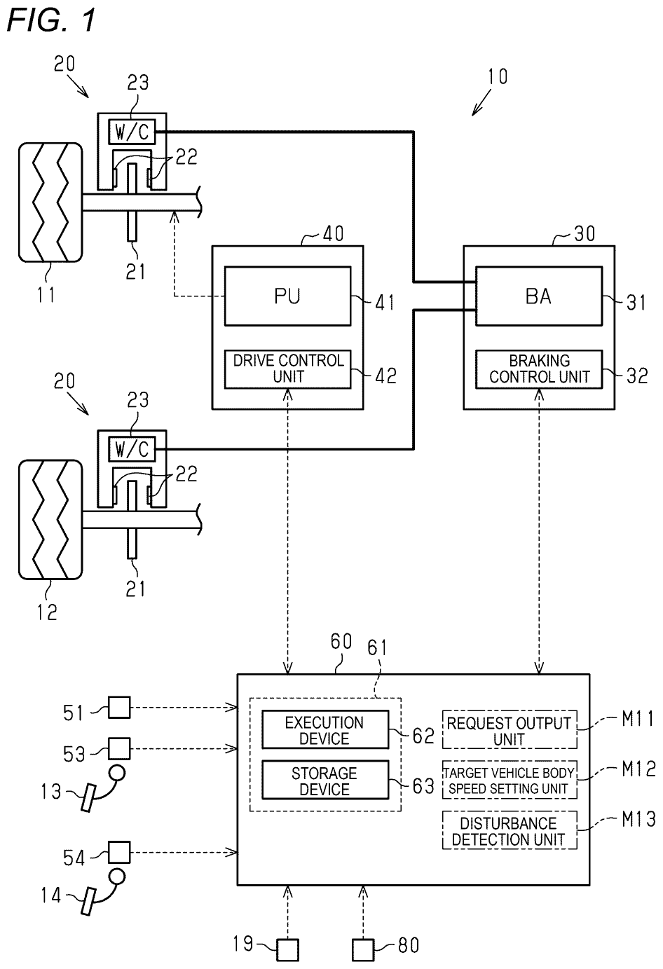

Hereinafter, a driving assistance device according to a first embodiment will be described with reference to FIGS. 1 to 4.

FIG. 1 illustrates a driving assistance device 60 and a vehicle 10 to which the driving assistance device 60 is applied.

The vehicle 10 is, for example, a four-wheeled vehicle. FIG. 1 illustrates one of the front wheels 11 and one of the rear wheels 12 among the wheels included in the vehicle 10. The vehicle 10 includes a braking device 30 and a driving device 40. An example of the braking device 30 is a friction braking device. FIG. 1 illustrates a hydraulic braking device as an example of the friction braking device. The braking device 30 includes a braking mechanism 20 corresponding to each wheel of the vehicle 10. FIG. 1 illustrates a front wheel drive vehicle that transmits driving force to the front wheels 11 as an example of the vehicle 10. The vehicle 10 may be a rear wheel drive vehicle that transmits driving force to the rear wheels 12, or may be a four-wheel drive vehicle that transmits driving force to the front wheels 11 and the rear wheels 12.

The vehicle 10 includes a braking operation member 13 that can be operated by a driver of the vehicle 10. An example of the braking operation member 13 is a brake pedal. The operation of the braking operation member 13 by the driver is referred to as a braking operation. The braking device 30 can generate the braking force according to the braking operation.

The vehicle 10 includes an accelerating operation member 14 that can be operated by the driver of the vehicle 10. An example of the accelerating operation member 14 is an accelerator pedal. The operation of the accelerating operation member 14 by the driver is referred to as an accelerating operation. The driving device 40 can generate a driving force according to the accelerating operation.

### Braking Device

As illustrated in FIG. 1, each braking mechanism 20 includes a rotating body 21, a friction portion 22, and a wheel cylinder 23. The rotating body 21 rotates integrally with the wheel. The braking mechanism 20 can apply a braking force to the wheel by pressing the friction portion 22 against the rotating body 21. As the hydraulic pressure in the wheel cylinder 23 increases, the force of pressing the friction portion 22 against the rotating body 21 increases. That is, the higher the hydraulic pressure in the wheel cylinder 23, the larger the braking force applied to the wheel. As an example, the braking mechanism 20 is a disc brake, but the braking mechanism 20 may be a drum brake.

The braking device 30 includes a braking actuator 31 and a braking control unit 32 which is a processing circuit for controlling the braking actuator 31. The braking actuator 31 is configured to be able to individually adjust the hydraulic pressure in a plurality of wheel cylinders 23.

As the braking device 30, a friction braking device configured to press the friction portion 22 against the rotating body 21 by mechanically transmitting the rotation of an electric motor may be adopted. The braking device 30 is not limited to the friction braking device, and may be a regenerative braking device.

The braking control unit 32 controls the braking force of the vehicle 10 by operating the braking actuator 31. The braking control unit 32 can mutually communicate with other processing circuits included in the vehicle 10. For example, the braking control unit 32 is connected to an in-vehicle network of the vehicle 10.

For example, the braking control unit 32 can receive a braking force instruction value FbR, which is an instruction value of the braking force of the vehicle 10, from the driving assistance device 60. The braking control unit 32 can operate the braking actuator 31 based on the braking force instruction value FbR.

### Driving Device

As illustrated in FIG. 1, the driving device 40 includes a drive source 41 and a drive control unit 42 which is a processing circuit for controlling the drive source 41. An example of the driving device 40 is a device that generates a driving force by the drive source 41 configured by an electric motor. The drive source 41 of the driving device 40 is not limited to a device configured by an electric motor, and an internal combustion engine may be adopted. In addition, an electric motor and an internal combustion engine may be adopted as drive sources. In addition, the drive source 41 may be an in-wheel motor in which an electric motor is attached to a wheel of each wheel of the vehicle 10.

The drive control unit 42 controls the driving force of the vehicle 10 by operating the drive source 41. The drive control unit 42 can mutually communicate with other processing circuits included in the vehicle 10. For example, the drive control unit 42 is connected to an in-vehicle network of the vehicle 10.

For example, the drive control unit 42 can receive a driving force instruction value FdR, which is an instruction value of the driving force of the vehicle 10, from the driving assistance device 60. The drive control unit 42 can operate the drive source 41 based on the driving force instruction value FdR.

### Various Sensors

The vehicle 10 includes various sensors. Detection signals from the various sensors are input to the in-vehicle network. FIG. 1 illustrates a wheel speed sensor 51, a brake operation amount sensor 53, and an accelerator operation amount sensor 54 as examples of the various sensors.

The wheel speed sensor 51 is a sensor that detects a wheel speed. The wheel speed sensor 51 is provided on each wheel. The driving assistance device 60 can calculate the wheel speed of each wheel based on the detection signal from the wheel speed sensor 51. The driving assistance device 60 can calculate the vehicle body speed VS of the vehicle 10 based on each wheel speed.

The brake operation amount sensor 53 can detect the operation of the braking operation member 13. For example, the brake operation amount sensor 53 can detect a braking operation amount Bp as the operation amount of the braking operation member 13. The brake operation amount sensor 53 can also detect whether or not the braking operation member 13 is operated.

The accelerator operation amount sensor 54 can detect an operation of the accelerating operation member 14. For example, the accelerator operation amount sensor 54 can detect the accelerating operation amount Ac as the operation amount of the accelerating operation member 14. The accelerator operation amount sensor 54 can also detect whether or not the accelerating operation member 14 is operated.

### Information Acquisition Device

As illustrated in FIG. 1, the vehicle 10 may include an information acquisition device 80. The information acquisition device 80 is a device for acquiring information of the periphery of the vehicle 10. For example, the driving assistance device 60 can use information acquired by the information acquisition device 80 via the in-vehicle network.

The information acquisition device 80 can acquire, for example, a relative distance to the vehicle 10 with respect to other vehicles, obstacles, and the like located at the periphery of the vehicle 10. The information acquisition device 80 can also acquire a shape of a road on which the vehicle 10 travels and recognize a lane. An example of the information acquisition device 80 is a camera. An example of the information acquisition device 80 is a detection device such as LiDAR and millimeter wave radar. Devices such as a camera and a detection device are not necessarily mounted on the vehicle 10. If the vehicle 10 includes a reception device that receives a signal from a device such as a camera provided outside the vehicle 10, information of the periphery of the vehicle 10 can be acquired.

Another example of the information acquisition device 80 is a GNSS receiver that receives a signal from a positioning satellite. The current location of the vehicle 10 can be specified based on the signal received by the GNSS receiver.

Another example of the information acquisition device 80 is a navigation system. Examples of the information that can be used by the navigation system include map information, facility information, traffic information, and information based on results of traveling of other vehicles other than the vehicle 10.

The information acquisition device 80 may be configured by one device among the above devices, or may be configured by combining two or more devices. The information acquisition device 80 may include a processing circuit that processes acquired information.

### Driving Assistance Device

The driving assistance device 60 can execute assistance control for assisting traveling of the vehicle 10.

When performing the assistance control, the driving assistance device 60 first sets a travel path. The driving assistance device 60 controls the vehicle 10 so that the vehicle 10 travels according to the set travel path. Specific control of the vehicle 10 is control of causing the vehicle body speed VS of the vehicle 10 to track the target vehicle body speed VSTr through adjustment of the driving force and the braking force of the vehicle 10. The assistance control may include control for assisting steering of the vehicle 10.

The driving assistance device 60 performs tracking control for adjusting the driving force and the braking force of the vehicle 10 based on the deviation between the vehicle body speed VS of the vehicle 10 and the target vehicle body speed VSTr. Specifically, feedback control is performed. The feedback control is, for example, PID control or PI control. The driving assistance device 60 calculates a braking force instruction value FbR and a driving force instruction value FdR as instruction values for causing the vehicle body speed VS to track the target vehicle body speed VSTr. The driving force instruction value FdR is increased so as to increase the driving force when, for example, the vehicle body speed VS becomes smaller than the target vehicle body speed VSTr due to insufficient driving force when the wheel goes over a step. For example, when the vehicle body speed VS becomes larger than the target vehicle body speed VSTr, the braking force instruction value FbR is increased so as to increase the braking force.

For example, the driving assistance device 60 executes the assistance control to cause the vehicle 10 to travel at a low speed. As an example of a scene in which the assistance control is executed, there is a scene in which the vehicle 10 is parked at a parking position. Hereinafter, the assistance control for parking the vehicle 10 may be referred to as parking assistance control. Note that the low speed is a speed low enough that the vehicle 10 can immediately come to a stop. A specific example of the speed is a speed of less than 10 km/h.

As will be described in detail later, the driving assistance device 60 allows the braking operation and the accelerating operation to be performed as the operation by the driver during the execution of the assistance control. When the driver performs an operation during execution of the assistance control, the driving assistance device 60 can suppress interference between the operation and the assistance control. For example, when the accelerating operation is performed during the execution of the assistance control, the driving assistance device 60 can suspend the tracking control. By suspending the tracking control, the vehicle 10 is caused to generate the driving force demanded by the driver with priority given to the accelerating operation.

As illustrated in FIG. 1, driving assistance device 60 includes a processing circuit 61. The processing circuit 61 includes an execution device 62 and a storage device 63. The storage device 63 stores various control programs to be executed by the execution device 62.

The driving assistance device 60 functions as various functional units when the execution device 62 executes the control program. FIG. 1 illustrates a demand output unit M11, a target vehicle body speed setting unit M12, and a disturbance detection unit M13 as functional units.

### Parking Assistance Control

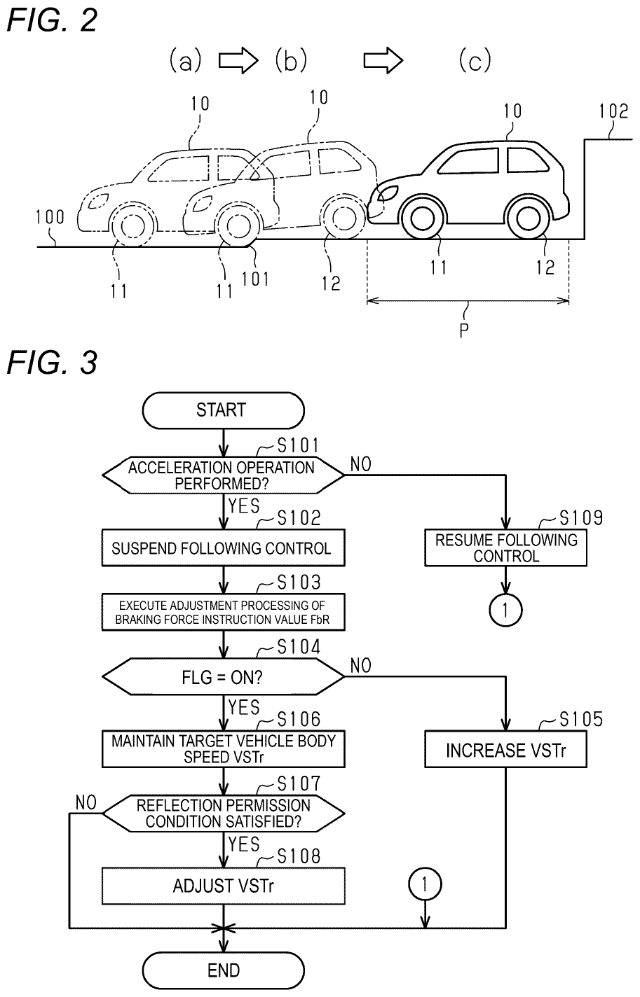

The assistance control in a scene where the vehicle 10 is to be parked will be described with reference to FIG. 2. The parking assistance control is control for causing the vehicle 10 to travel on a travel path from the current position of the vehicle 10 to the target parking position P.

(a) of FIG. 2 illustrates the vehicle 10 of when starting the assistance control. (b) of FIG. 2 illustrates the vehicle 10 that is traveling by the assistance control. (c) of FIG. 2 illustrates the vehicle 10 in a state of being stopped at a target parking position P. A white arrow in FIG. 2 indicates the advancing direction of the vehicle 10. In the example illustrated in FIG. 2, the rear side of the vehicle 10 is facing the advancing direction. That is, an example in which the vehicle 10 is to be moved backward is illustrated. Regarding the vehicle 10 moving backward as in the example illustrated in the order of (a), (b), and (c) of FIG. 2, the rear wheel 12 is referred to as a preceding wheel, and the front wheel 11 is referred to as a following wheel. Note that in the assistance control, the vehicle 10 can also be moved forward. Unlike the example illustrated in FIG. 2, regarding the vehicle 10 moving forward, the front wheel 11 is referred to as a preceding wheel, and the rear wheel 12 is referred to as a following wheel.

The target parking position P will be described. An example of the target parking position P is a position set in advance by the driver. The driving assistance device 60 can store an arbitrary position selected by the driver as the target parking position P. For example, a parking lot or the like at the driver's home can be set as the target parking position P. Another example of the target parking position P is a parking lot registered in the map information. As still another example, as the target parking position P, a parking partition in which a wheel stopper, a partition line, an obstacle, and the like are recognized by a camera or the like may be set. Describing using FIG. 2 as an example, a space in front of a wall 102 which is an obstacle can be recognized as the target parking position P where the vehicle 10 can be parked. The parking partition may be automatically recognized by the driving assistance device 60, or may be recognized by the driving assistance device 60 according to a demand of the driver. Note that FIG. 2 illustrates a parking lot in which the wall 102 exists as an example, but the wall 102 may be installed or the wall 102 may not be installed in the parking lot.

The driving assistance device 60 can start the parking assistance control when the target parking position P exists near the vehicle 10. For example, when the vehicle 10 approaches a preset target parking position P, a registered target parking position P, or the like, parking assistance control is started. For example, the parking assistance control is started when a parking partition at the periphery of the vehicle 10 is recognized and the target parking position P is set. Note that the parking assistance control is not executed when the braking operation is performed. The driving assistance device 60 can also start the assistance control according to a demand of the driver. For example, the assistance control may be started based on the driver's operation to turn ON an assistance switch 19.

For example, the driving assistance device 60 stops the vehicle 10 at the target parking position P, and then ends the parking assistance control. The driving assistance device 60 may end the assistance control when the braking operation is performed by the driver during the execution of the assistance control.

As illustrated in FIG. 2, there may be a step 101 on the road surface 100. When the step 101 is present on the travel path of the vehicle 10, the preceding wheel, which is a wheel located in the advancing direction of the vehicle 10, of the front wheel 11 and the rear wheel 12 climbs over the step 101, and then the following wheel climbs over the step 101. In (a) of FIG. 2, the rear wheel 12, which is a preceding wheel, is in contact with the step 101. In (b) of FIG. 2, the front wheel 11, which is a following wheel, is in contact with the step 101. In the example illustrated in FIG. 2, the rear wheel 12 which is a preceding wheel and the front wheel 11 which is a following wheel pass through the step 101 in this order.

### Demand Output Unit

The demand output unit M11 can output the braking force instruction value FbR to the braking control unit 32. The demand output unit M11 can output the driving force instruction value FdR to the drive control unit 42.

### Target Vehicle Body Speed Setting Unit

The target vehicle body speed setting unit M12 sets the target vehicle body speed VSTr. The target vehicle body speed VSTr is a value used for the assistance control and is a target value of the vehicle body speed VS.

For example, the target vehicle body speed setting unit M12 sets the target vehicle body speed VSTr to a constant speed. In this case, the vehicle 10 is controlled to travel at a constant speed by the assistance control. For example, the target vehicle body speed VSTr is set in advance as a speed at which the vehicle 10 travels at a low speed. The target vehicle body speed setting unit M12 can also adjust the target vehicle body speed VSTr according to the accelerating operation amount Ac. The adjustment of the target vehicle body speed VSTr according to the accelerating operation amount Ac will be described later.

### Disturbance Detection Unit

The disturbance detection unit M13 can detect a disturbance part present on the travel path. The disturbance part is an element that affects the vehicle 10 to temporarily disturb the correspondence relationship between the driving force and the vehicle body speed. For example, the disturbance part increases the travel resistance when the wheel passes through. The step present on the travel path is an example of a disturbance part for the vehicle 10 to travel on the travel path. For example, even when driving forces of the same magnitude are transmitted, the vehicle body speed may be slower on a road surface with a step than on a road surface without a step. Other examples of the disturbance part include a sudden change in a road surface gradient, a depression in a road surface, a muddy road surface, and freezing of a road surface.

The step will be described in more detail. The step in the present specification is a bump of a road surface that the vehicle 10 can pass over. The shape of the bump is not particularly limited as long as the bump causes a height difference on the road surface. For example, a height difference may occur stepwise, or a height difference may occur due to undulation. In the example illustrated in FIG. 2, the road surface 100 closer to the wall 102 is higher than the step 101 with the step 101 as a boundary. Unlike the example illustrated in FIG. 2, the height of the road surfaces with the step as a boundary may be constant. That is, only the periphery of the step may be raised. In addition, the step is not limited to the fact that the road surface itself is raised, and also includes the fact that a height difference is formed by a structure installed on the road surface, a falling object that fell on the road surface, and the like.

Hereinafter, an example of a case where the disturbance detection unit M13 detects a step as an example of a disturbance part present on a travel path will be described.

When detecting a step present on the travel path, the disturbance detection unit M13 turns ON the flag FLG. The initial value of the flag FLG is OFF. When the flag FLG is turned ON, this indicates that there is a step on the travel path of the vehicle 10. For example, the disturbance detection unit M13 turns OFF the flag FLG when all the wheels included in the vehicle 10 pass through the step. For example, the disturbance detection unit M13 turns OFF the flag FLG when the vehicle body speed VS becomes “0”.

The disturbance detection unit M13 can detect a step based on the state of the vehicle 10 during execution of the assistance control. An example will be described. As described above, the driving force instruction value FdR is increased to increase the driving force when the wheel goes over the step during the execution of the assistance control. Therefore, the step can be detected based on the variation of the driving force instruction value FOR when the wheel goes over the step. For example, when a step is detected based on the variation of the driving force instruction value FdR when the preceding wheel passes through the step, the flag FLG is in an ON state when the following wheel goes over the step. For example, when a step is detected based on the variation of the driving force instruction value FdR when the preceding wheel starts to go over the step, the flag FLG is turned ON while the preceding wheel is going over the step.

The disturbance detection unit M13 can also detect a step by recognizing the step present at the periphery of the vehicle 10. An information acquisition device 80 such as a camera can be used to recognize the step. By using the information acquisition device 80 in this manner, it is also possible to detect the step before the wheel comes into contact with the step.

The disturbance detection unit M13 can also detect a step based on “position information of a step”. For example, by storing the position of the step detected when the step is detected, the step can be detected based on the position information of the step and the position information of the vehicle 10 when the vehicle travels the place where the vehicle has traveled in the past again. The disturbance detection unit M13 is not limited to the step detected when the vehicle 10 travels, and can receive and use the position information of the step. For example, the disturbance detection unit M13 can also detect a step based on the position information of the step detected by the other vehicle. The position information of the step detected by the other vehicle can be received by the information acquisition device 80 as information based on a result of traveling of the other vehicle.

The disturbance detection unit M13 may detect a step by any one of the means for detecting a step, or may detect a step by combining two or more means. For example, the step can be detected even from outside a range that can be recognized by a camera or the like by using the position information of the step. Thereafter, by actually recognizing the presence or absence of the step with a camera or the like after the distance between the vehicle 10 and the step approaches, the accuracy of detecting the step can be improved.

### Processing When Accelerating Operation is Performed During Execution of Assistance Control

The processing when the accelerating operation is performed during the execution of the assistance control will be described with reference to FIG. 3. FIG. 3 illustrates a flow of processing executed by the driving assistance device 60. This processing routine is repeatedly executed at predetermined periods during execution of the assistance control.

When the present processing routine is started, first, in step S101, the driving assistance device 60 determines whether or not an accelerating operation is being performed. When the accelerating operation is performed (S101: YES), the driving assistance device 60 proceeds the processing to step S102. In step S102, the driving assistance device 60 suspends the tracking control. That is, the control for causing the vehicle body speed VS to track the target vehicle body speed VSTr is suspended. On the other hand, when the accelerating operation is performed, the driving force corresponding to the accelerating operation amount Ac is transmitted to the drive wheel. While the tracking control is suspended, the adjustment of the driving force and the braking force is not performed even if the vehicle body speed VS is deviated from the target vehicle body speed VSTr.

When the tracking control is suspended in step S102, the driving assistance device 60 proceeds the processing to step S103. In step S103, the adjustment processing of the braking force instruction value FbR is executed. This processing is a processing of adjusting the braking force instruction value FbR after the accelerating operation is canceled. Specifically, regarding the braking force adjusted after the accelerating operation is canceled, the braking force instruction value FbR is adjusted so as to increase the change amount per unit time of the braking force. When the vehicle body speed VS converges to the target vehicle body speed VSTr, the driving assistance device 60 may end the processing of increasing the change amount per unit time of the braking force. Thereafter, the driving assistance device 60 proceeds the processing to step S104.

In step S104, the driving assistance device 60 determines whether or not the flag FLG is turned ON. That is, whether or not a step is detected on the travel path is determined. When the flag FLG is turned OFF, that is, when a step is not detected (S104: NO), the driving assistance device 60 proceeds the processing to step S105.

In step S105, the driving assistance device 60 causes the target vehicle body speed setting unit M12 to increase the target vehicle body speed VSTr. The target vehicle body speed setting unit M12 increases the target vehicle body speed VSTr according to the accelerating operation amount Ac. Thereafter, the driving assistance device 60 once ends the present processing routine.

On the other hand, when the flag FLG is turned ON in the processing of step S104, that is, when a step is detected (S104: YES), the driving assistance device 60 proceeds the processing to step S106.

In step S106, the driving assistance device 60 causes the target vehicle body speed setting unit M12 to maintain the target vehicle body speed VSTr. The target vehicle body speed setting unit M12 maintains the target vehicle body speed VSTr without adjustment. Thereafter, the driving assistance device 60 proceeds the processing to step S107.

In step S107, the driving assistance device 60 determines whether or not the reflection permission condition is satisfied. The reflection permission condition is a condition for permitting the accelerating operation amount Ac to be reflected on the target vehicle body speed VSTr when the reflection permission condition is satisfied.

As an example, the driving assistance device 60 determines that the reflection permission condition is satisfied when the accelerating operation amount Ac is larger than the permission determination value Acth1. On the other hand, when the accelerating operation amount Ac is less than or equal to the permission determination value Acth1, it is determined that the reflection permission condition is not satisfied. In this case, the reflection permission condition is satisfied with a smaller accelerating operation amount Ac the smaller the permission determination value Acth1. The accelerating operation amount Ac for satisfying the reflection permission condition increases the larger the permission determination value Acth1. For example, the permission determination value Acth1 can be set as a value larger than a value corresponding to the driving force necessary for the wheel of the vehicle 10 to go over the step. As the permission determination value Acth1, a value calculated in advance through an experiment or the like can be used. As the permission determination value Acth1, a value that changes according to the state of the vehicle 10 can also be used. For example, when the travel route of the vehicle 10 is an uphill, the permission determination value Acth1 may be made smaller the larger the road surface gradient. For example, when the travel route of the vehicle 10 is a downhill, the permission determination value Acth1 may be made larger the larger the road surface gradient. For example, the permission determination value Acth1 may be made smaller the longer the time during which the accelerating operation is continued. For example, the permission determination value Acth1 may be made smaller the heavier the vehicle weight of the vehicle 10. For example, when there is no other vehicle, obstacle, or the like at the periphery of the vehicle 10, the permission determination value Acth1 may be made smaller.

In a case where the reflection permission condition is not satisfied in the processing of step S107 (S107: NO), the driving assistance device 60 once ends the present processing routine. On the other hand, when the reflection permission condition is satisfied in the processing of step S107 (S107: YES), the driving assistance device 60 proceeds the processing to step S108.

In step S108, the driving assistance device 60 causes the target vehicle body speed setting unit M12 to adjust the target vehicle body speed VSTr. For example, the target vehicle body speed setting unit M12 increases the target vehicle body speed VSTr according to the accelerating operation amount Ac. The target vehicle body speed setting unit M12 can also lower the target vehicle body speed VSTr within a range in which the target vehicle body speed VSTr is increased according to the accelerating operation amount Ac. For example, when the accelerating operation member 14 is operated so that the accelerating operation amount Ac gradually decreases, the once increased target vehicle body speed VSTr can be gradually decreased. The driving assistance device 60 ends the present processing routine when adjusting the target vehicle body speed VSTr.

That is, when a step is detected and the accelerating operation amount Ac is less than or equal to the permission determination value Acth1, the target vehicle body speed VSTr is not adjusted according to the accelerating operation amount Ac. On the other hand, when a step is detected and the accelerating operation amount Ac is larger than the permission determination value Acth1, the target vehicle body speed VSTr is adjusted according to the accelerating operation amount Ac.

When the accelerating operation is not performed in step S101 (S101: NO), the driving assistance device 60 proceeds the processing to step S109. In step S109, the driving assistance device 60 resumes the tracking control when the tracking control is suspended. Thereafter, the driving assistance device 60 once ends the present processing routine. As described above, the driving assistance device 60 resumes the tracking control when the accelerating operation performed during the execution of the assistance control is canceled. That is, the driving assistance device 60 suspends the tracking control while the accelerating operation member 14 is being operated during the execution of the assistance control. As a result, the driving force based on the accelerating operation amount Ac is generated while the accelerating operation member 14 is being operated during the execution of the assistance control. Note that when the tracking control is not suspended, the driving assistance device 60 continuously executes the tracking control. Thereafter, the driving assistance device 60 once ends the present processing routine.

### Operations and Effects of First embodiment

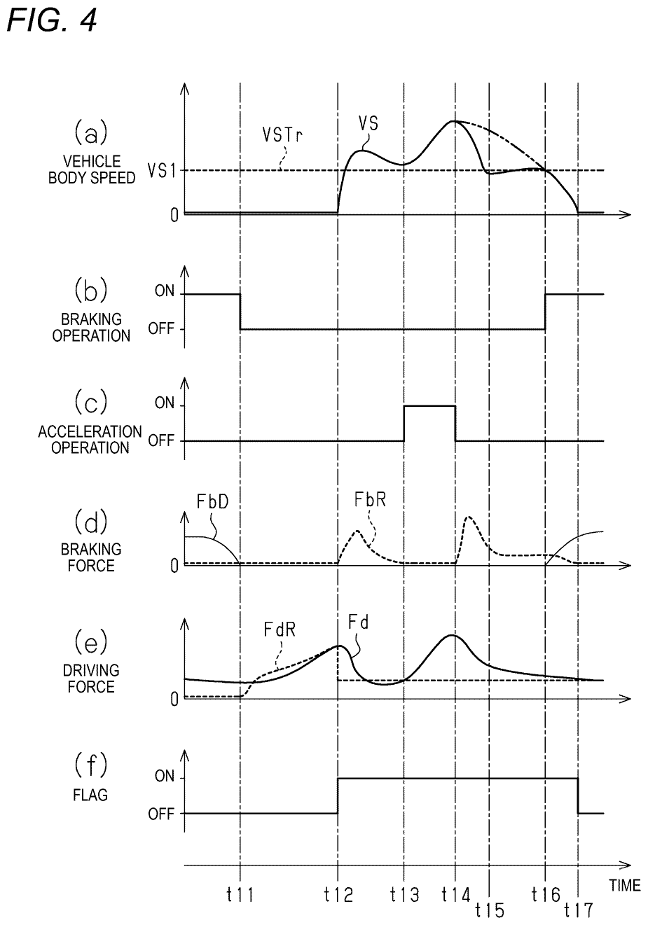

Operations and effects of the present embodiment will be described with reference to FIGS. 2 and 4.

The example described below will be described as a transition from a state in which the rear wheel 12 is in contact with the step 101 and the vehicle 10 is stopped as illustrated in (a) of FIG. 2. Describing this state in detail, when the rear wheel 12, which is a preceding wheel, comes into contact with the step 101 in a situation where the vehicle 10 is moving backward, a braking force is applied by the braking operation performed by the driver, and the vehicle 10 is stopped.

The solid line illustrated in (d) of FIG. 4 indicates the transition of the braking force FbD applied to the vehicle 10 according to the braking operation amount Bp by the braking operation of the driver. The broken line illustrated in (d) of FIG. 4 indicates the transition of the braking force instruction value FbR. The sum of the braking force FbD and the braking force generated according to the braking force instruction value FbR corresponds to the braking force applied to the vehicle 10.

As illustrated in (b) of FIG. 4, the braking operation is performed in a period before timing t11. The braking operation is canceled at timing t11. Accordingly, as illustrated in (d) of FIG. 4, the braking force FbD becomes “0” at timing t11.

When the braking operation is canceled at timing t11, the parking assistance control is started. At this time, the rear wheel 12, which is the preceding wheel, is in contact with the step 101, and thus the vehicle 10 does not start unless the driving force for climbing over the step 101 is transmitted. That is, the vehicle body speed VS is “0” as illustrated in (a) of FIG. 4 while the driving force enough to climb over the step 101 is insufficient. In the example illustrated in FIG. 4, a period from timing t11 to timing t12 corresponds to a period in which the driving force is insufficient. In the period from timing t11 to timing t12, the driving force instruction value FdR is gradually increased by the feedback control as illustrated in (e) of FIG. 4. As the driving force instruction value FdR increases in this manner, the driving force Fd of the vehicle 10 increases. The target vehicle body speed VSTr is set as a constant value “VS1” by the target vehicle body speed setting unit M12 as indicated with a broken line in (a) of FIG. 4.

In the example illustrated in FIG. 4, at timing t12, the driving force Fd of the vehicle 10 exceeds the driving force necessary for causing the rear wheel 12 to go over the step 101. As a result, the rear wheel 12 goes over the step 101. The state illustrated in (a) of FIG. 2 thereby shifts to the state illustrated in (b) of FIG. 2. That is, since the vehicle 10 starts after timing t12, the vehicle body speed VS increases as illustrated in (a) of FIG. 4. Note that at this time, the step is detected by the disturbance detection unit M13 based on the transition of the driving force and the transition of the vehicle body speed VS when the rear wheel 12, which is the preceding wheel, goes over the step 101. Therefore, as illustrated in (f) of FIG. 4, the flag FLG is turned ON after timing t12. That is, a period after timing t12 is a period in which the step is detected.

When the rear wheel 12 passes through the step 101, the vehicle body speed VS increases, but in order to suppress the vehicle body speed VS from deviating from the target vehicle body speed VSTr, the driving force instruction value FdR is decreased by the tracking control as illustrated in (e) of FIG. 4. Furthermore, the braking force instruction value FbR is increased by the tracking control as illustrated in (d) of FIG. 4. As a result, as illustrated in (a) of FIG. 4, the vehicle body speed VS tracks the target vehicle body speed VSTr.

As in the example illustrated in FIG. 4, the vehicle body speed VS may temporarily increase as the wheel passes through the step in a state where the driving force is increased so that the wheel goes over the step. If the accelerating operation is performed at this time, the following problem arises. If the target vehicle body speed VSTr at the time of going over the step is set to be higher than the certain speed even if the accelerating operation is performed, there is a possibility that the vehicle 10 that has passed through the step is controlled to jump out even if the accelerating operation is canceled after passing through the step. In this respect, according to the driving assistance device 60, the vehicle body speed VS can be suppressed from becoming excessively large as described below.

In the example illustrated in FIG. 4, the accelerating operation is started at timing t13 as illustrated in (c) of FIG. 4. The accelerating operation is continued in a period from timing t13 to timing t14. At timing t14, the accelerating operation is canceled. Note that in the example illustrated in FIG. 4, the accelerating operation amount Ac in the accelerating operation is less than or equal to the permission determination value Acth1.

As the accelerating operation is being performed, the tracking control is suspended in a period from timing t13 to timing t14 (S102). Therefore, the driving force Fd is increased according to the accelerating operation amount Ac. Accordingly, the vehicle body speed VS increases. In addition, even when the vehicle body speed VS is deviated from the target vehicle body speed VSTr due to the suspension of the tracking control, the braking force instruction value FbR is not increased as illustrated in (d) of FIG. 4. Accompanying an increase in the driving force Fd, the front wheel 11, which is a following wheel, goes over the step 101 between timing t13 and timing t14. For example, timing t14 is a timing at which the driver who has confirmed that the following wheel has passed over the step cancels the accelerating operation.

According to the driving assistance device 60, the tracking control is suspended when the accelerating operation is performed, so that the operation by the driver can be suppressed from interfering with the tracking control. The vehicle 10 can be easily traveled according to the demand of the driver by prioritizing the accelerating operation by the driver over the tracking control.

In a period from timing t13 to timing t14, the target vehicle body speed VSTr is maintained without being adjusted by performing the accelerating operation when a step is detected (S106). As a result, after the accelerating operation is canceled at timing t14, the vehicle body speed VS is controlled to track the target vehicle body speed VSTr that is the same value as before the accelerating operation is started.

Here, a comparative example in a case where the target vehicle body speed VSTr is increased according to the accelerating operation will be described. The transition of the vehicle body speed VS in the case of the comparative example is indicated by a two-dot chain line in (a) of FIG. 4. When the target vehicle body speed VSTr is increased while the accelerating operation is performed as in the case of the comparative example, the vehicle body speed VS is decreased so as to track the target vehicle body speed VSTr that starts to be decreased after the accelerating operation is canceled. The vehicle body speed VS of the comparative example at which the tracking control is performed as described above decreases to “VS1” which is the initial speed at, for example, timing t16.

In contrast to such a comparative example, according to the present embodiment in which the target vehicle body speed VSTr is maintained even when the accelerating operation is performed when a step is detected, the target vehicle body speed VSTr is a low value deviated from the vehicle body speed VS at the time point when the accelerating operation is canceled. Therefore, the vehicle body speed VS can be decreased to “VS1” by timing t15 which is earlier than timing t16. As described above, the driving assistance device 60 is configured such that the accelerating operation amount Ac is not reflected on the target vehicle body speed VSTr when a step present on the travel path of the vehicle 10 is detected. Therefore, when the accelerating operation is canceled after the vehicle passes through the step, the driving force and the braking force are easily controlled in a direction of decreasing the vehicle body speed VS when the wheel passes through the step. As a result, the vehicle body speed VS after the wheel passes through the step can be suppressed from excessively increasing.

According to the driving assistance device 60 that maintains the target vehicle body speed VSTr even when the accelerating operation is performed, for example, the following effects can also be obtained. Assume that the driver who has performed the accelerating operation to go over the step tries to switch from the accelerating operation to the braking operation after passing through the step. According to the driving assistance device 60, the vehicle body speed VS can be rapidly reduced after the accelerating operation is canceled, and hence the distance traveled by the vehicle 10 until the braking operation is performed after the accelerating operation is canceled and the braking force is actually generated can be shortened. As a result, even if the braking operation is not quickly performed after the accelerating operation is canceled, the vehicle 10 can be suppressed from greatly moving.

In the driving assistance device 60, with respect to the braking force after the accelerating operation is canceled at timing t14, the braking force instruction value FbR is adjusted so as to increase the change amount per unit time of the braking force (S103). Therefore, a large braking force can be generated more quickly after the accelerating operation is canceled. As a result, the vehicle body speed VS can be reduced quickly to further shorten the time during which the vehicle body speed VS is deviated from the target vehicle body speed VSTr.

Note that as illustrated in (b) of FIG. 4, the braking operation is started again at timing t16. At timing t17, the vehicle 10 is stopped and the parking assistance control is ended. The vehicle 10 has reached the target parking position P at timing t17 as illustrated in (c) of FIG. 2.

In the driving assistance device 60, even when a step is detected, if the accelerating operation amount Ac is larger than the permission determination value Acth1, the target vehicle body speed VSTr can be adjusted according to the accelerating operation amount Ac. If the accelerating operation amount Ac is not reflected on the target vehicle body speed VSTr when the accelerating operation amount Ac is large, the divergence between the actual driving force of the vehicle 10 and the driving force corresponding to the target vehicle body speed VSTr may become larger. When the accelerating operation is canceled in a state where the divergence of the driving force is large, the behavior of the vehicle 10 may become unstable as the divergence of the driving force is canceled after the accelerating operation is canceled. In this regard, according to the driving assistance device 60 of the present embodiment, the divergence between the actual driving force of the vehicle 10 and the driving force corresponding to the target vehicle body speed VSTr is less likely to become large.

### Second Embodiment

A driving assistance device of a second embodiment is different from that of the first embodiment in that the tracking control is not suspended even if the accelerating operation is performed during the execution of the assistance control. That is, the driving assistance device of the second embodiment continues the tracking control of controlling the vehicle body speed VS so as to track the target vehicle body speed VSTr during the execution of the assistance control. The driving assistance device of the second embodiment can change the mode of setting the target vehicle body speed VSTr according to the accelerating operation amount Ac when the accelerating operation is performed during the execution of the assistance control.

Hereinafter, the driving assistance device according to the second embodiment will be described in detail. The description of the configuration common with the first embodiment will be omitted as appropriate.

In the second embodiment, the target vehicle body speed setting unit M12 sets the target vehicle body speed VSTr to the minimum speed Vmin when the assistance control is started. The minimum speed Vmin is a speed set to cause the vehicle 10 to travel at a low speed.

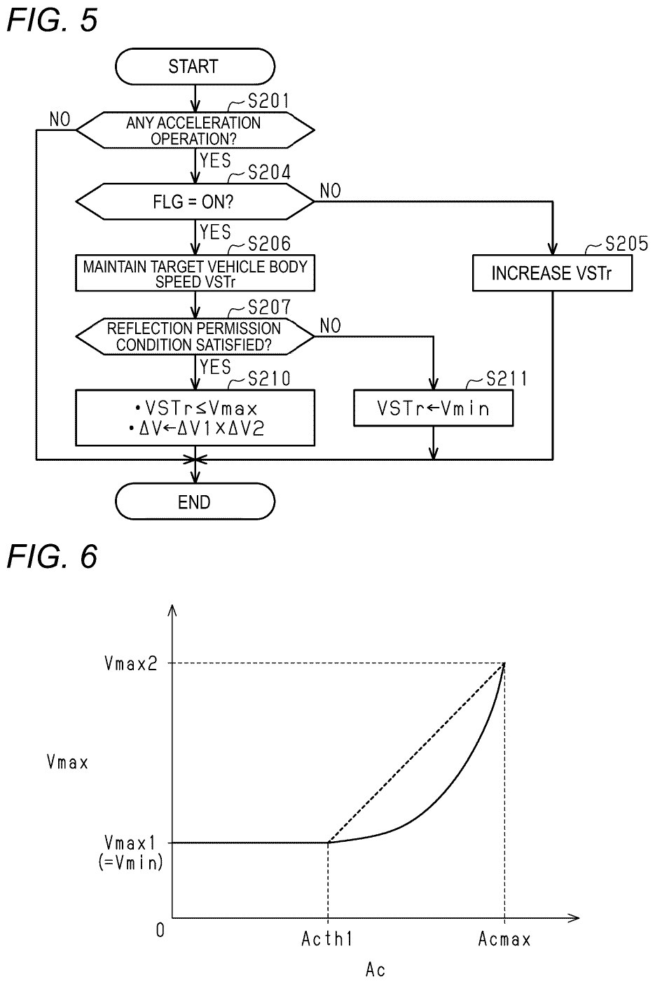

FIG. 5 illustrates a flow of processing executed by the driving assistance device 60 of the second embodiment. This processing routine is repeatedly executed at predetermined periods during execution of the assistance control.

When the present processing routine is started, first, in step S201, the driving assistance device 60 determines whether or not an accelerating operation is being performed. When the accelerating operation is not performed (S201: NO), the driving assistance device 60 once ends this processing routine. On the other hand, when the accelerating operation is performed (S201: YES), the driving assistance device 60 proceeds the processing to step S204.

In step S204, the driving assistance device 60 determines whether or not the flag FLG is turned ON. That is, whether or not a step is detected on the travel path is determined. When the flag FLG is turned OFF, that is, when a step is not detected (S204: NO), the driving assistance device 60 proceeds the processing to step S205.

In step S205, the driving assistance device 60 causes the target vehicle body speed setting unit M12 to increase the target vehicle body speed VSTr. The target vehicle body speed setting unit M12 increases the target vehicle body speed VSTr according to the accelerating operation amount Ac. More specifically, the target vehicle body speed VSTr is increased such that the driving force is transmitted according to the relationship between the accelerating operation amount Ac and the driving force when the accelerating operation is performed in a case where the assistance control is not performed. Thereafter, the driving assistance device 60 once ends the present processing routine.

On the other hand, when the flag FLG is turned ON in the processing of step S204, that is, when a step is detected (S204: YES), the driving assistance device 60 proceeds the processing to step S206.

In step S206, the driving assistance device 60 causes the target vehicle body speed setting unit M12 to maintain the target vehicle body speed VSTr. The target vehicle body speed setting unit M12 maintains the target vehicle body speed VSTr without adjustment. Thereafter, the driving assistance device 60 proceeds the processing to step S207.

In step S207, the driving assistance device 60 determines whether or not the reflection permission condition is satisfied. As the reflection permission condition, a condition common with the condition described as the processing of step S107 in the first embodiment can be adopted.

When the reflection permission condition is satisfied in the processing of step S207 (S207: YES), the driving assistance device 60 proceeds the processing to step S210.

In step S210, the driving assistance device 60 causes the target vehicle body speed setting unit M12 to adjust the target vehicle body speed VSTr. For example, the target vehicle body speed setting unit M12 increases the target vehicle body speed VSTr according to the accelerating operation amount Ac. The target vehicle body speed setting unit M12 can also lower the target vehicle body speed VSTr within a range in which the target vehicle body speed VSTr is increased according to the accelerating operation amount Ac.

Here, an example of the function of the target vehicle body speed setting unit M12 in the second embodiment will be described.

The target vehicle body speed setting unit M12 can set the maximum speed Vmax as an upper limit of the target vehicle body speed VSTr. In other words, the target vehicle body speed setting unit M12 can adjust the target vehicle body speed VSTr within the range of less than or equal to the maximum speed Vmax.

The target vehicle body speed setting unit M12 can set a change gradient ΔV when increasing or decreasing the target vehicle body speed VSTr. The change gradient ΔV corresponds to a value obtained by time-differentiating the target vehicle body speed VSTr. The change gradient ΔV is set so as to gradually change the vehicle body speed VS as compared with the change gradient of the vehicle body speed VS in a case where the driving force corresponding to the accelerating operation amount Ac when the assistance control is not performed is transmitted.

As a processing of step S210, when the accelerating operation amount Ac is increased, the target vehicle body speed setting unit M12 increases the target vehicle body speed VSTr so that the change gradient of the target vehicle body speed VSTr is set to the change gradient ΔV with the upper limit as the maximum speed Vmax. When the accelerating operation amount Ac is decreased, the target vehicle body speed setting unit M12 decreases the target vehicle body speed VSTr so that the change gradient of the target vehicle body speed VSTr is a value obtained by multiplying the change gradient ΔV by “−1”.

The maximum speed Vmax will be described with reference to FIG. 6. FIG. 6 illustrates an example of the relationship between the accelerating operation amount Ac and the maximum speed Vmax.

For example, in a range in which the accelerating operation amount Ac is less than or equal to the permission determination value Acth1, a constant speed “Vmax1” is set as the maximum speed Vmax regardless of the magnitude of the accelerating operation amount Ac. The speed “Vmax1” at this time may be equal to the minimum speed Vmin.

For example, in a range in which the accelerating operation amount Ac is larger than the permission determination value Acth1, the maximum speed Vmax is set to be larger the larger the accelerating operation amount Ac. In a range in which the accelerating operation amount Ac is larger than the permission determination value Acth1, the maximum speed Vmax is set to a speed in a range larger than the speed “Vmax1” and less than or equal to the speed “Vmax2”. The speed “Vmax2” is a speed set as the maximum speed Vmax when the accelerating operation amount Ac is the maximum value. In FIG. 6, the maximum value of the accelerating operation amount Ac is displayed as “Acmax”. As indicated by a solid line in FIG. 6, the accelerating operation amount Ac and the maximum speed Vmax may have a relationship of a quadratic function in a range in which the accelerating operation amount Ac is larger than the permission determination value Acth1. Alternatively, as indicated by a broken line in FIG. 6, the accelerating operation amount Ac and the maximum speed Vmax may have a relationship of a linear function in a range where the accelerating operation amount Ac is larger than the permission determination value Acth1.

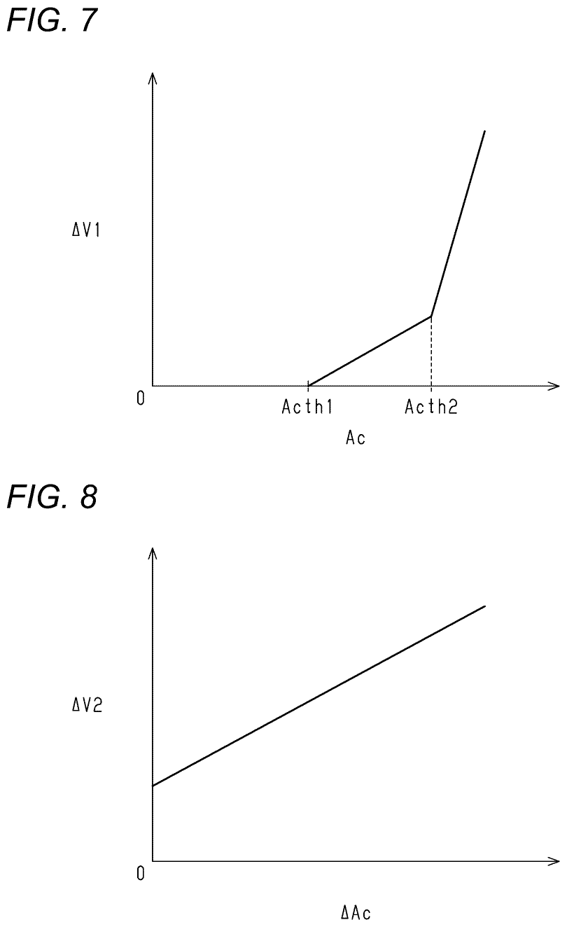

The change gradient ΔV will be described with reference to FIGS. 7 and 8.

For example, the target vehicle body speed setting unit M12 can calculate the change gradient ΔV by multiplying the first variable ΔV1 and the second variable ΔV2.

FIG. 7 illustrates an example of the relationship between the accelerating operation amount Ac and the first variable ΔV1. The acceleration determination value Acth2 illustrated in FIG. 7 is a value larger than the permission determination value Acth1.

The first variable ΔV1 is “0” in a range in which the accelerating operation amount Ac is less than or equal to the permission determination value Acth1. The first variable ΔV1 is calculated as a larger value the larger the accelerating operation amount Ac in a range in which the accelerating operation amount Ac is larger than the permission determination value Acth1. In a range in which the accelerating operation amount Ac is larger than the acceleration determination value Acth2, the gradient of the first variable ΔV1 is set large as compared with a range in which the accelerating operation amount Ac is larger than the permission determination value Acth1 and less than or equal to the acceleration determination value Acth2. That is, in a range in which the accelerating operation amount Ac is larger than the acceleration determination value Acth2, the first variable ΔV1 is calculated so as to change the first variable ΔV1 more greatly according to the change in the accelerating operation amount Ac.

FIG. 8 illustrates an example of the relationship between the operation change amount ΔAc and the second variable ΔV2. The operation change amount ΔAc is a value obtained by time-differentiating the accelerating operation amount Ac. The second variable ΔV2 is calculated as a larger value the larger the operation change amount ΔAc.

The processing of step S210 for adjusting the target vehicle body speed VSTr can be rephrased as follows. The processing of step S210 is a processing of suppressing the absolute value of the change gradient of the vehicle body speed VS with respect to the operation change amount ΔAc to be small as compared with when the accelerating operation is performed in a case where the assistance control is not performed. The processing of step S210 is a processing of adjusting the target vehicle body speed VSTr so as to increase the absolute value of the change gradient ΔV the larger the accelerating operation amount Ac. In the processing of step S210, the mode of adjusting the target vehicle body speed VSTr is changed between a case where the accelerating operation amount Ac is larger than the permission determination value Acth1 and less than or equal to the acceleration determination value Acth2 and a case where the accelerating operation amount Ac is larger than the acceleration determination value Acth2. Specifically, when the accelerating operation amount Ac is larger than the acceleration determination value Acth2, the target vehicle body speed VSTr is adjusted so as to change the change gradient ΔV more greatly according to the change in the accelerating operation amount Ac than when the accelerating operation amount Ac is less than or equal to the acceleration determination value Acth2.

Returning to FIG. 5, when the target vehicle body speed VSTr is adjusted in step S210, the driving assistance device 60 ends this processing routine.

On the other hand, when the reflection permission condition is not satisfied in the processing of step S207 (S207: NO), the driving assistance device 60 proceeds the processing to step S211.

In step S211, the driving assistance device 60 causes the target vehicle body speed setting unit M12 to set the target vehicle body speed VSTr to the minimum speed Vmin. That is, when the state in which the accelerating operation amount Ac is less than or equal to the permission determination value Acth1 is continued, the target vehicle body speed VSTr is continuously maintained at the minimum speed Vmin. When the accelerating operation amount Ac becomes less than or equal to the permission determination value Acth1 from a state of being larger than the permission determination value Acth1, the target vehicle body speed VSTr is updated to the minimum speed Vmin. After setting the target vehicle body speed VSTr to the minimum speed Vmin, the driving assistance device 60 ends this processing routine.

### Operations and Effects of Second Embodiment

Operations and effects of the present embodiment will be described with reference to FIGS. 2, 9 and 10.

The example described below will be described as a transition from a state in which the rear wheel 12 is in contact with the step 101 and the vehicle 10 is stopped as illustrated in (a) of FIG. 2, similarly to the description of FIG. 4.

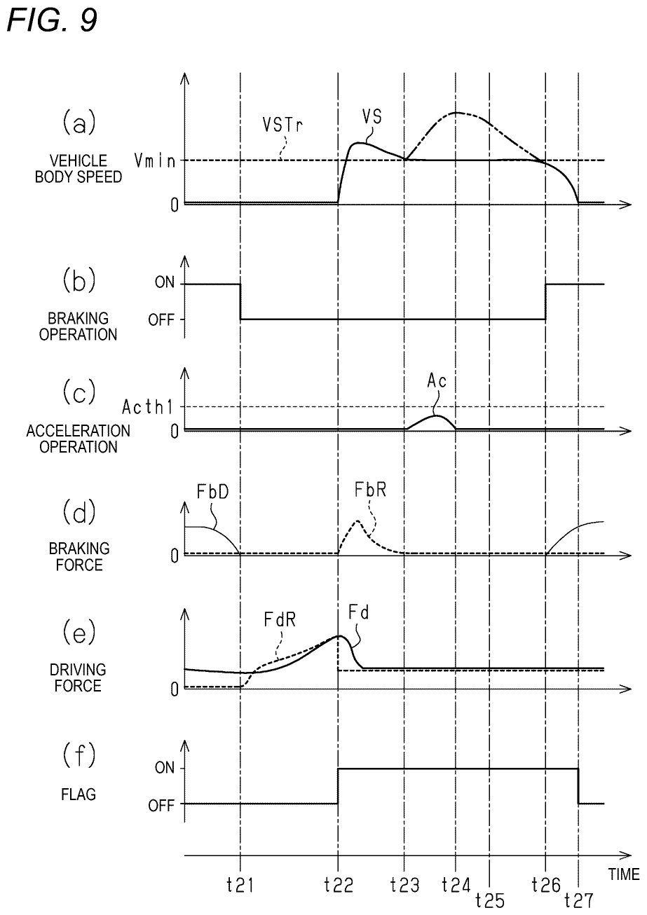

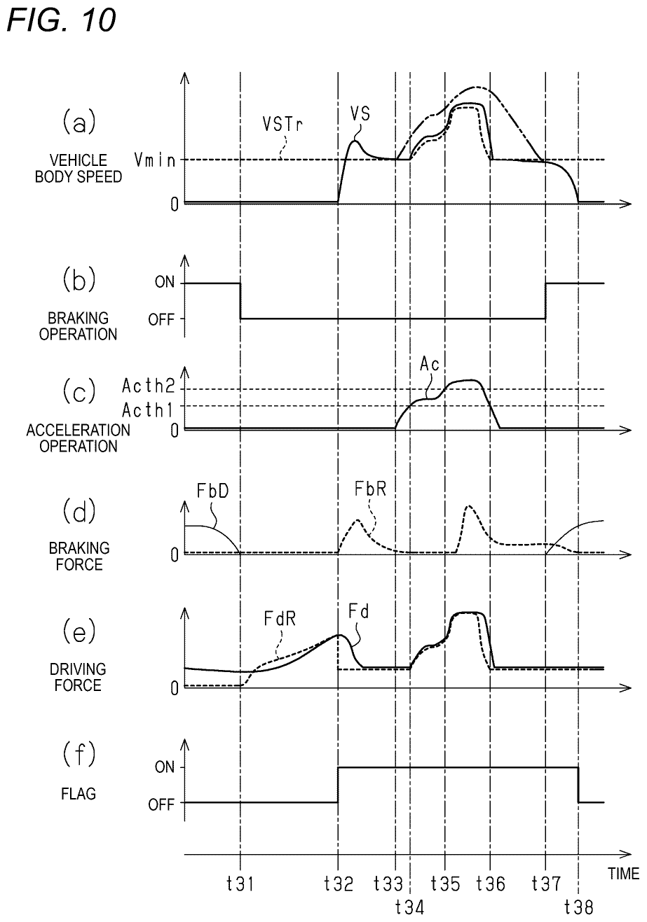

Note that the solid lines illustrated in (d) of FIG. 9 and (d) of FIG. 10 indicate the transition of the braking force FbD applied to the vehicle 10 according to the braking operation amount Bp by the driver's braking operation. The broken lines illustrated in (d) of FIG. 9 and (d) of FIG. 10 indicate the transition of the braking force instruction value FbR. The sum of the braking force FbD and the braking force generated according to the braking force instruction value FbR corresponds to the braking force applied to the vehicle 10.

The example illustrated in FIG. 9 is an example for a case where the accelerating operation amount Ac is less than or equal to the permission determination value Acth1 as illustrated in (c) of FIG. 9.

As illustrated in (b) of FIG. 9, the braking operation is performed in a period before timing t21. The braking operation is canceled at timing t21. Accordingly, as illustrated in (d) of FIG. 9, the braking force FbD becomes “0” at timing t21.

When the braking operation is canceled at timing t21, the parking assistance control is started. At this time, the rear wheel 12, which is the preceding wheel, is in contact with the step 101, and thus the vehicle 10 does not start unless the driving force for climbing over the step 101 is transmitted. That is, the vehicle body speed VS is “0” as illustrated in (a) of FIG. 9 while the driving force enough to go over the step 101 is insufficient. In the example illustrated in FIG. 9, a period from timing t21 to timing t22 corresponds to a period in which the driving force is insufficient. In the period from timing t21 to timing t22, the driving force instruction value FOR is gradually increased by the feedback control as illustrated in (e) of FIG. 9. As the driving force instruction value FdR increases in this manner, the driving force Fd of the vehicle 10 increases. The target vehicle body speed VSTr is set as a constant value “Vmin” by the target vehicle body speed setting unit M12 as indicated with a broken line in (a) of FIG. 9.

In the example illustrated in FIG. 9, at timing t22, the driving force Fd of the vehicle 10 exceeds the driving force necessary for causing the rear wheel 12 to go over the step 101. As a result, the rear wheel 12 goes over the step 101. The state illustrated in (a) of FIG. 2 thereby shifts to the state illustrated in (b) of FIG. 2. That is, since the vehicle 10 starts after timing t22, the vehicle body speed VS increases as illustrated in (a) of FIG. 9. Note that at this time, the step is detected by the disturbance detection unit M13 based on the transition of the driving force and the transition of the vehicle body speed VS when the rear wheel 12, which is the preceding wheel, goes over the step 101. Therefore, as illustrated in (f) of FIG. 9, the flag FLG is turned ON after timing t22. That is, a period after timing t22 is a period in which the step is detected.

When the rear wheel 12 passes through the step 101, the vehicle body speed VS increases, but in order to suppress the vehicle body speed VS from deviating from the target vehicle body speed VSTr, the driving force instruction value FdR is decreased by the tracking control as illustrated in (e) of FIG. 9. Furthermore, the braking force instruction value FbR is increased by the tracking control as illustrated in (d) of FIG. 9. As a result, as illustrated in (a) of FIG. 9, the vehicle body speed VS tracks the target vehicle body speed VSTr.

In the example illustrated in FIG. 9, the accelerating operation is started at timing t23. The accelerating operation is continued in a period from timing t23 to timing t24. At timing t24, the accelerating operation is canceled.

As illustrated in (c) of FIG. 9, the accelerating operation amount Ac increases from timing t23 according to the accelerating operation. The accelerating operation amount Ac is decreased without exceeding the permission determination value Acth1 and becomes “0” at timing t24.

Although the accelerating operation is performed in the period from timing t23 to timing t24, the reflection permission condition is not satisfied because the accelerating operation amount Ac is less than or equal to the permission determination value Acth1. Therefore, as indicated by a broken line in (a) of FIG. 9, the target vehicle body speed VSTr is set to the minimum speed Vmin (S211).

Even after timing t23, the driving force Fd is controlled as illustrated in (e) of FIG. 9 so that the vehicle body speed VS tracks the target vehicle body speed VSTr by the tracking control. As a result, as illustrated in (a) of FIG. 9, the vehicle body speed VS is maintained at the minimum speed Vmin. Note that in (a) of FIG. 9, as a comparative example, an example of the vehicle body speed in a case where the driving force corresponding to the accelerating operation amount Ac is transmitted to the drive wheel when the accelerating operation is performed is indicated by a two-dot chain line.

Note that after timing t24, as illustrated in (b) of FIG. 9, the braking operation is started again at timing t26 after timing t25. At timing t27, the vehicle 10 is stopped and the parking assistance control is ended. The example illustrated in FIG. 9 is an example in which the vehicle 10 is stopped before the following wheel reaches the step after the preceding wheel goes over the step.

The example illustrated in FIG. 10 is an example in a case where the accelerating operation amount Ac is increased to be larger than the permission determination value Acth1 as illustrated in (c) of FIG. 10.

As illustrated in (b) of FIG. 10, the parking assistance control is started when the braking operation is canceled at timing t31. In the example illustrated in FIG. 10, a period from timing t31 to timing t32 corresponds to a period in which the driving force for going over the step 101 is insufficient. In the period from timing t31 to timing t32, the driving force instruction value FdR is gradually increased by the feedback control as illustrated in (e) of FIG. 10. As the driving force instruction value FdR increases in this manner, the driving force Fd of the vehicle 10 increases. The target vehicle body speed VSTr is set as a constant value “Vmin” by the target vehicle body speed setting unit M12 as indicated with a broken line in (a) of FIG. 10.

In the example illustrated in FIG. 10, at timing t32, the driving force Fd of the vehicle 10 exceeds the driving force necessary for causing the rear wheel 12 to go over the step 101. That is, since the vehicle 10 starts after timing t32, the vehicle body speed VS increases as illustrated in (a) of FIG. 10. Note that at this time, the step is detected by the disturbance detection unit M13 based on the transition of the driving force and the transition of the vehicle body speed VS when the rear wheel 12, which is the preceding wheel, goes over the step 101. Therefore, as illustrated in (f) of FIG. 10, the flag FLG is turned ON after timing t32. That is, a period after timing t32 is a period in which the step is detected.

When the rear wheel 12 passes through the step 101, the vehicle body speed VS increases, but in order to suppress the vehicle body speed VS from deviating from the target vehicle body speed VSTr, the driving force instruction value FdR is decreased by the tracking control as illustrated in (e) of FIG. 10. Furthermore, the braking force instruction value FbR is increased by the tracking control as illustrated in (d) of FIG. 10. As a result, as illustrated in (a) of FIG. 10, the vehicle body speed VS tracks the target vehicle body speed VSTr.

In the example illustrated in FIG. 10, the accelerating operation is started at timing t33. As illustrated in (c) of FIG. 10, the accelerating operation amount Ac increases from timing t33 according to the accelerating operation. The accelerating operation amount Ac is larger than the permission determination value Acth1 after timing t34. The accelerating operation amount Ac is larger than the acceleration determination value Acth2 after timing t35. Thereafter, the accelerating operation amount Ac starts to decrease, becomes less than or equal to the permission determination value Acth1 at timing t36, and then decreases to “0”.

Since the accelerating operation amount Ac is larger than the permission determination value Acth1 at timing t34, the reflection permission condition is satisfied. Therefore, the target vehicle body speed VSTr is adjusted as indicated by a broken line in (a) of FIG. 10 (S210).

Since the accelerating operation amount Ac becomes less than or equal to the permission determination value Acth1 at timing t36, the target vehicle body speed VSTr is set to the minimum speed Vmin as indicated by a broken line in (a) of FIG. 10 (S211).

In a period from timing t34 to timing t36, the target vehicle body speed VSTr is adjusted by the change gradient ΔV calculated based on the accelerating operation amount Ac. When the accelerating operation amount Ac becomes larger than the acceleration determination value Acth2 at timing t35, the change gradient ΔV is calculated to be larger. As a result, as illustrated in (a) of FIG. 10, the change gradient of the target vehicle body speed VSTr is larger after timing t35 than in the period from timing t34 to timing t35.

After the accelerating operation amount Ac starts decreasing, the decreasing speed of the target vehicle body speed VSTr increases while the accelerating operation amount Ac is larger than the acceleration determination value Acth2. When the accelerating operation amount Ac decreases to less than or equal to the acceleration determination value Acth2, the decreasing speed of the target vehicle body speed VSTr is made gentle.

Even after timing t33, the driving force Fd is controlled as illustrated in (e) of FIG. 10 so that the vehicle body speed VS tracks the target vehicle body speed VSTr by the tracking control. As a result, as illustrated in (a) of FIG. 10, the vehicle body speed VS is maintained at the minimum speed Vmin during a period until timing t34 when the target vehicle body speed VSTr is maintained at the minimum speed Vmin. Furthermore, in the period from timing t33 to timing t34, the driving force instruction value FdR is also maintained so as to maintain the target vehicle body speed VSTr set to the minimum speed Vmin even when the accelerating operation amount Ac is increased. After timing t34, the vehicle body speed VS changes so as to track the target vehicle body speed VSTr to be adjusted. Furthermore, the driving force instruction value FdR also changes according to the change in the target vehicle body speed VSTr. Note that in (a) of FIG. 10, as a comparative example, an example of the vehicle body speed in a case where the driving force corresponding to the accelerating operation amount Ac is transmitted to the drive wheel when the accelerating operation is performed is indicated by a two-dot chain line.

Note that as illustrated in (b) of FIG. 10, the braking operation is started again at timing t37. At timing t38, the vehicle 10 is stopped and the parking assistance control is ended.

As described above, according to the driving assistance device 60 of the second embodiment, the vehicle body speed VS can be maintained when the accelerating operation amount Ac is less than or equal to the permission determination value Acth1, and the accelerating operation can be reflected on the vehicle body speed VS when the accelerating operation amount Ac is larger than the permission determination value Acth1.

In the driving assistance device 60 of the second embodiment, when the accelerating operation amount Ac is larger than the permission determination value Acth1 during the execution of the assistance control, the target vehicle body speed VSTr is adjusted based on the accelerating operation amount Ac. The target vehicle body speed VSTr is adjusted according to the change gradient ΔV calculated based on the accelerating operation amount Ac. Furthermore, an upper limit is set to the target vehicle body speed VSTr. At this time, the tracking control is configured to be continuously executed. As a result, according to the second embodiment, the vehicle body speed VS can be reduced as compared with the case where the driving force corresponding to the accelerating operation amount Ac is transmitted. That is, an excessive increase in the vehicle body speed VS can be suppressed while accelerating the vehicle 10 according to the accelerating operation of the driver during the execution of the assistance control.

According to the driving assistance device 60 of the second embodiment, the change gradient ΔV is increased in a range in which the accelerating operation amount Ac is larger than the acceleration determination value Acth2. Therefore, when the accelerating operation amount Ac decreases in a range in which the accelerating operation amount Ac is larger than the acceleration determination value Acth2, the target vehicle body speed VSTr is adjusted to decrease quickly. When the accelerating operation amount Ac is decreased in a range in which the accelerating operation amount Ac is larger than the acceleration determination value Acth2, the driving force can be reduced quickly. Alternatively, when the accelerating operation amount Ac is decreased in a range in which the accelerating operation amount Ac is larger than the acceleration determination value Acth2, the braking force can be increased quickly.

### Modified Example

The first embodiment and the second embodiment can be modified as follows. The first embodiment, the second embodiment, and the following modified examples can be implemented in combination with each other within a technically consistent scope.
In the flow of the processing described with reference to FIG. 3, the processing of step S103 may be omitted. That is, it is not essential to perform the processing of adjusting the braking force instruction value FbR after the accelerating operation is canceled.
In the flow of the processing described with reference to FIG. 3, the processing of step S107 and step S108 may be omitted. That is, when the accelerating operation is performed and the step is detected, the target vehicle body speed VSTr may be maintained regardless of whether or not the reflection permission condition is satisfied.
In each of the above embodiments, the case where the vehicle 10 is moved backward has been described, but, even in a case where the vehicle 10 is moved forward, the flow of processing described with reference to FIG. 3 or FIG. 5 can be applied.
FIG. 4 of the first embodiment illustrates a case where the accelerating operation is performed after the preceding wheel passes through the step. Unlike this example, a case where the accelerating operation is performed when the preceding wheel goes over the step is considered. In such a case, if the step has been detected before the preceding wheel comes into contact with the step, the target vehicle body speed VSTr can be maintained even when the preceding wheel goes over the step by each processing illustrated in FIG. 3 as in the case of the first embodiment.

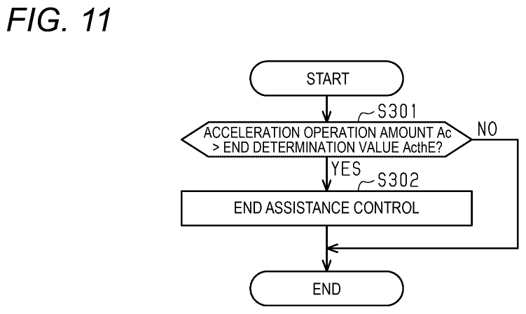

Similarly, FIGS. 9 and 10 of the second embodiment illustrate the case where the accelerating operation is performed after the preceding wheel passes through the step. If the step has been detected before the preceding wheel comes into contact with the step, the target vehicle body speed VSTr can be adjusted even if the accelerating operation is performed when the preceding wheel goes over the step by each processing illustrated in FIG. 5 as in the case of the second embodiment.
In each of the above embodiments, the parking assistance control has been exemplified as the assistance control. The assistance control can be executed not only when parking the vehicle 10. The assistance control can be executed in a scene where the vehicle 10 travels at a low speed. For example, there is a scene where the vehicle 10 running on a roadway enters a site in a facility such as a commercial facility adjacent to the road at a low speed. There may be a step between the road and the facility. For example, there may be a step at a boundary between the roadway and the sidewalk. In addition, for example, there may be a step on the boundary between the site of the facility and the road. In the above scene as well, the driving assistance device 60 can be applied similarly to the case described in each of the above embodiments, and the vehicle 10 can be caused to travel by assistance control. The travel path in the above scene is a route on which the vehicle 10 travels to the target position in the site of the facility.
The processing routine illustrated in FIG. 11 may be executed by the driving assistance device 60 of the first embodiment. The processing routine illustrated in FIG. 11 can be repeatedly executed at a predetermined period during execution of the assistance control. The processing routine illustrated in FIG. 11 is executed in parallel with the processing routine illustrated in FIG. 3. When the present processing routine is started, first, in step S301, the driving assistance device 60 determines whether or not the accelerating operation amount Ac is larger than an end determination value ActhE. The end determination value ActhE is set as a value larger than the permission determination value Acth1. When the accelerating operation amount Ac is larger than the end determination value ActhE (S301: YES), the driving assistance device 60 proceeds the processing to step S302 and ends the assistance control. As a result, the vehicle 10 is traveled by the operation of the driver. Thereafter, the driving assistance device 60 ends the present processing routine. On the other hand, when the accelerating operation amount Ac is less than or equal to the end determination value ActhE (S301: NO), the driving assistance device 60 once ends the present processing routine. That is, in this case, the assistance control is continuously executed.

As described above, when the accelerating operation amount Ac is larger than the end determination value ActhE due to the driver demanding a larger driving force, the assistance control can be ended. In this case, the assistance control can be restarted thereafter. For example, the assistance control may be started again when the accelerating operation amount Ac becomes less than or equal to a control restart threshold value such that the accelerating operation amount Ac becomes less than or equal to the end determination value ActhE. Alternatively, when a start condition different from the accelerating operation amount Ac such as the vehicle 10 being stopped is satisfied, the assistance control may be started again. As an example of a case where the driver demands a larger driving force, a case where the driver passes through a parking partition set as the target parking position P and heads to a parking partition different from the parking partition is considered. As another example, a case where it is desired to accelerate the vehicle 10 to a speed higher than a low speed after the vehicle 10 has passed through the step is considered.
In each of the above embodiments, the case where the disturbance detection unit M13 detects a step has been exemplified as an example of the disturbance part present on the travel path. Even when a disturbance part other than a step is detected by the disturbance detection unit M13, the vehicle 10 can be controlled in the same manner as in each of the above embodiments. In this case, the flag FLG being ON indicates that a disturbance part is present on the travel path of the vehicle 10.
The processing circuit 61 and other processing circuits included in the vehicle 10 may have any of the following configurations [a] to [c]. [a] A circuit including one or more processors that executes various processing according to a computer program. The processor includes a processing device. Examples of the processing device include a CPU, a DSP, and a GPU. The processor includes a memory. Examples of the memory include a RAM, a ROM, and a flash memory. The memory stores program codes or instructions configured to cause a processing device to execute processing. The memory, that is, the computer readable medium, includes any available medium that can be accessed by a general-purpose or dedicated computer. For example, the CPU corresponds to the execution device 62. For example, the memory corresponds to the storage device 63. [b] A circuit including one or more hardware circuits that execute various processing. Examples of the hardware circuit include an application specific integrated circuit (ASIC), a complex programmable logic device (CPLD), and a field programmable gate array (FPGA). [c] A circuit including a processor that executes some of the various processing according to a computer program, and a hardware circuit that executes the remaining processing of the various processing.
Some or all of the functions implemented by the braking control unit 32 and the drive control unit 42 may be implemented by the driving assistance device 60.
Some of the functions implemented by the driving assistance device 60 may be implemented by another processing circuit connected to the driving assistance device 60.

1. A driving assistance device configured to execute an assistance control for assisting traveling of a vehicle by causing a vehicle body speed of the vehicle to track a target vehicle body speed through adjustment of a driving force and a braking force of the vehicle, the driving assistance device comprising:
a target vehicle body speed setting unit configured to set the target vehicle body speed; and
a disturbance detection unit configured to detect a disturbance part present on a travel path of the vehicle; wherein
the target vehicle body speed setting unit is configured to:
adjust the target vehicle body speed according to an accelerating operation amount that is an operation amount of an accelerating operation member operated by a driver of the vehicle when the disturbance part is not detected, and
not adjust the target vehicle body speed according to the accelerating operation amount when the disturbance part is detected.

2. The driving assistance device according to claim 1, wherein
the target vehicle body speed setting unit is configured to:
not adjust the target vehicle body speed according to the accelerating operation amount when the disturbance part is detected and the accelerating operation amount is less than or equal to a permission determination value, and
adjust the target vehicle body speed according to the accelerating operation amount when the disturbance part is detected and the accelerating operation amount is larger than the permission determination value.

3. The driving assistance device according to claim 2, wherein
the assistance control is ended when the accelerating operation amount is larger than an end determination value, and
the end determination value is a value larger than the permission determination value.

4. The driving assistance device according to claim 3, wherein
while the accelerating operation member is being operated during execution of the assistance control, adjustment of the driving force and the braking force for causing the vehicle body speed to track the target vehicle body speed is suspended to generate the driving force based on the accelerating operation amount.

5. The driving assistance device according to claim 3, wherein
when the accelerating operation member is operated during the execution of the assistance control, a change amount per unit time of the braking force is increased with respect to the braking force adjusted after the operation of the accelerating operation member is canceled.

6. The driving assistance device according to claim 2, wherein
while the assistance control is being executed, adjustment of the driving force and the braking force for causing the vehicle body speed to track the target vehicle body speed is continued, and
the target vehicle body speed setting unit is configured to:
when the disturbance part is detected and the accelerating operation amount is larger than the permission determination value, adjust the target vehicle body speed such that an absolute value of a change gradient that is a value obtained by time-differentiating the target vehicle body speed becomes larger as the accelerating operation amount becomes larger.

7. The driving assistance device according to claim 6, wherein
the target vehicle body speed setting unit is configured to:
when the disturbance part is detected and the accelerating operation amount is larger than an acceleration determination value, adjust the target vehicle body speed so as to change the change gradient more greatly according to a change in the accelerating operation amount, as compared with when the accelerating operation amount is less than or equal to the acceleration determination value, and
the acceleration determination value is a value larger than the permission determination value.

8. The driving assistance device according to claim 2, wherein
when the accelerating operation member is operated during the execution of the assistance control, a change amount per unit time of the braking force is increased with respect to the braking force adjusted after the operation of the accelerating operation member is canceled.

9. The driving assistance device according to claim 2, wherein
while the accelerating operation member is being operated during execution of the assistance control, adjustment of the driving force and the braking force for causing the vehicle body speed to track the target vehicle body speed is suspended to generate the driving force based on the accelerating operation amount.

10. The driving assistance device according to claim 1, wherein
while the accelerating operation member is being operated during execution of the assistance control, adjustment of the driving force and the braking force for causing the vehicle body speed to track the target vehicle body speed is suspended to generate the driving force based on the accelerating operation amount.

11. The driving assistance device according to claim 1, wherein
when the accelerating operation member is operated during the execution of the assistance control, a change amount per unit time of the braking force is increased with respect to the braking force adjusted after the operation of the accelerating operation member is canceled.
